(19) United States
(12) Patent Application Publication
(10) Pub. No.: US 2018/0269641 A1
(43) Pub. Date: Sep. 20, 2018

(54) COMBINED POWER SOCKET FOR ARTIFICIAL CHRISTMAS TREE

(71) Applicant: Feng Ding, Xiaogan (CN)

(72) Inventor: Feng Ding, Xiaogan (CN)

(21) Appl. No.: 15/721,445

(22) Filed: Sep. 29, 2017

(30) Foreign Application Priority Data
Mar. 17, 2017 (CN) 201720264058.6

(51) Int. Cl. H01R 33/92; H01R 13/04; A47G 33/08

(52) U.S. Cl. CPC H01R 33/92; A47G 33/08; H01R 13/04

(57) ABSTRACT

The present disclosure relates to a combined power socket for artificial Christmas trees, including pairs, they can be set in the ring structure of rod or tube on the outer surface of the first and second socket, the lateral wall of the two on or near the lateral wall is formed at the outlet hole. The hole and the two one inside by a wire leads the first conductive connector is also one of the outlet hole through the guide wire leads to a second conductive contact with the first conductive connector of the adapter or an external power socket and adapter plug. At least one of the outlet holes of the two ends is also provided with at least one power supply connector through a conducting wire. The present disclosure relates to a combined power socket two first and second as a group, and can be connected with the other group are connected with each other to achieve interconnection, at the same time through the power supply connector leads from each combination type power socket for external devices, such as lamp series power supply, which has the advantages of simpler structure, more convenient connections to external devices.

### TECHNICAL FIELD

The present disclosure relates to a power socket, in particular to a combined power supply socket which can be used to enlarge the number of the socket through the interconnection to be used for the artificial Christmas tree.

### BACKGROUND

The string is widely used for indoor and outdoor decorating Christmas trees, decorations are essential festivals. A large number of general configuration to decorate the Christmas lights string 5-10 or above. At present, setting multiple string plug and jack adapter for power supply socket string, Jack number is generally two to ten, so can only be connected with two to ten strings. If you need to connect more string will be equipped with one or more additional power socket, which need to use one or more electrical socket. Generally, one side of the wall on the general configuration of a city outlet, it is easy to appear mains outlet is not enough, or the need to configure additional plug plate, the use of inconvenience. And in the process of assembly, the need for workers to climb down the wire, assembly is not safe.

Therefore, the connecting terminal is fixed on the Christmas tree trunk in the combined power, when the trunk of the upper and lower segments connected, fixed on the trunk in the combined electric connection terminals are electrically connected with each other, such as the application date is Dec. 24, 2015, the electric connector China utility model patent No. 20152107394.7 patent publication. However, the wires of the electric connector are extended and connected in the trunk, the assembly cost is high, and the electric connection cannot be observed in the use, and the utility model has great safety hidden trouble.

The utility model relates to a combined power socket which is disclosed in the patent application date of May 24, 2013 and the patent number 201320289695 of the utility model can be sheathed on the periphery of the trunk. However, the socket of the combined power supply socket is arranged on one of the socket body, and the manufacturing process is complex and needs to be improved.

### SUMMARY

The purpose of the present disclosure is to provide a combined power socket with simple structure.

A combined power socket, including supporting each other first and second socket, the socket and the socket was first second can be set in the ring structure of rod or tube outer surface; the first socket and socket second in one of the formation of the first end is provided with a plurality of Jack, jack set a conductive piece, another form first end is provided with a plurality of conductive pins and a plurality of the plurality of jacks corresponding to the lateral wall and both on or near the lateral wall is formed with the socket outlet hole communicated with the inner hole of the socket outlet; the first and one of the second socket through the wire leads the first conductive connector is also one of the outlet hole through the guide wire leads to a second conductive contact with the first conductive connector of the adapter or an external power socket and adapter plug; the At least one of the first outlet and the second socket is also provided with at least one power supply connector through a conducting wire.

Preferably, the first socket and the second socket are formed on at least one of them with an extension, which can be inserted into another ring, so that the two can be separated and connected together.

As a kind of embodiment, the first socket includes a substrate of a ring; from the inner periphery and the outer periphery of the substrate perpendicular to the substrate and to the first side of the substrate extending from the annular inner wall and the outer wall; the inner wall and the outer wall of the end to seal the coverplate, the inner wall and the outer wall surrounded the annular space; extending from the block inserted from the wall to the second side of the substrate; and from the substrate toward the substrate second side and a plurality of columns, the substrate corresponding to the plurality of column is formed with a base plate and column through both ends of the body and a plurality of through holes as the jack. The conductive member is inserted into the plurality of jacks from the first side of the substrate, and the conductive member is electrically connected to the conductive wire introduced through the outlet hole.

As a kind of embodiment, the insert is 4-piece, symmetrical distribution; the jack is 4, a symmetrical distribution, and each jack is arranged between two adjacent inserts, and two jacks as a group, the same group within the conductive member electrically connected.

For one embodiment, the conductive parts for the size and the diameter of the metal tube, Jack, Jack of the same group in the metal tube toward the end cover through an arc-shaped conductive tube or conductive rod or conductive metal wires are electrically connected together.

Preferably, the second side of the substrate is formed with a ring body connecting the column body and insert the outer surface of the column height and the ring body of the same, but less than the height of insert, which inserts more than ring body extends beyond to the second side of the substrate.

As an embodiment of the second socket includes a second substrate ring; from the inner periphery of the substrate second and the outer peripheral side of the first vertical on the substrate and second substrate extending room the inner wall and the outer wall of the second ring second; which is connected with the inner wall and the outer wall of the end of second to seal the second the cover second substrate, second inner wall and the second wall of the annular space; from second to second and the inner wall of the side of the second substrate and extending the insert second pieces; and from the second substrate toward the second substrate second side stretch out of the more than second columns, the second substrate corresponding to the second column position is formed with a plurality of second through the second substrate and the two column ends of the through hole. The plurality of conductive pins are inserted into the second through hole and extend from the end the second column, and the conductive pins are electrically connected with the conductive wires which at introduced through the corresponding outlet holes.

As the embodiment of the invention, the second inserting piece is a piece of 4 pieces, which is uniformly and symmetrically distributed; the 4-column body is also provided with a plurality of the same, and each of the second cylinders is provided with a symmetrical distribution of the second columns.

As a kind of embodiment, the second side of the second substrate is formed with a second body connecting the second cylinders and second insert on the outer surface, height and the second column the second ring of the same, but less than second insert height, second to insert the second ring body extends more than the distance to the second sale of the second substrate.

As a kind of embodiment, the first plug seat in a tree of the lower segment, second socket is sheathed on the upper section of the tree, the upper section of the lower section and connected together, the first and second electrically connected socket.

The present disclosure is used for the combined power supply socket of artificial Christmas tree first and second socket two seats of a group, and can be connected with other groups connected to the interconnection to expand the number of sockets, at the same time through the power supply joint extracted from each combination type power socket for lamp series power supply, which has the advantages of simpler structure, more convenient light string connection.

### BRIEF DESCRIPTION OF THE DRAWINGS

FIG. 1 Schematic diagram of the combined power supply socket of one embodiment of the present disclosure.

FIG. 2 shows the explosion of the first socket in FIG. 1.

FIG. 3 Schematic diagram of the conductive part of the first socket in FIG. 2. FIG. 1 shows the explosion of the second socket in FIG. 4.

FIG. 5 is the embodiment of the first socket and the second socket connection diagram.

FIG. 6 is the explosion of the combined power socket used in the Christmas tree.

FIG. 7 is the combined power supply socket of the present disclosure, winch is used for the combination of the Christmas tree.

### DETAILED DESCRIPTION

The combined power supply socket of the present disclosure is further described in detail according to the concrete embodiment and the drawing.

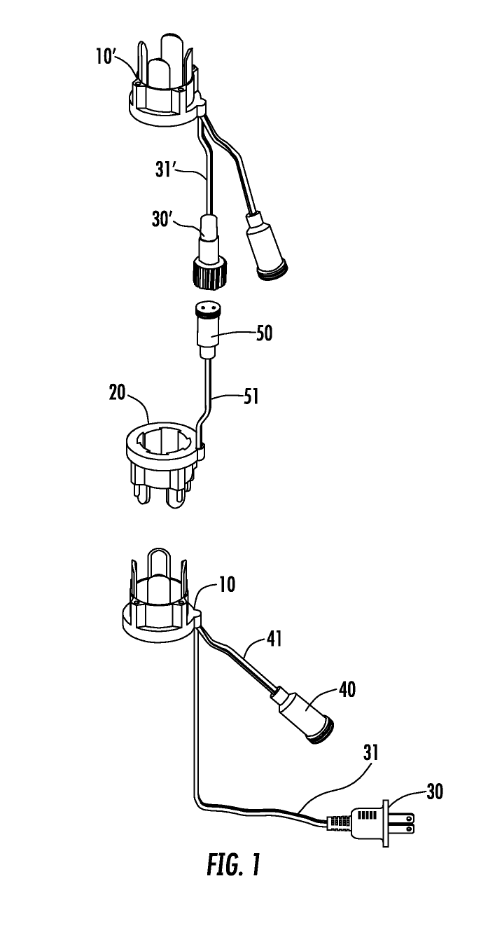

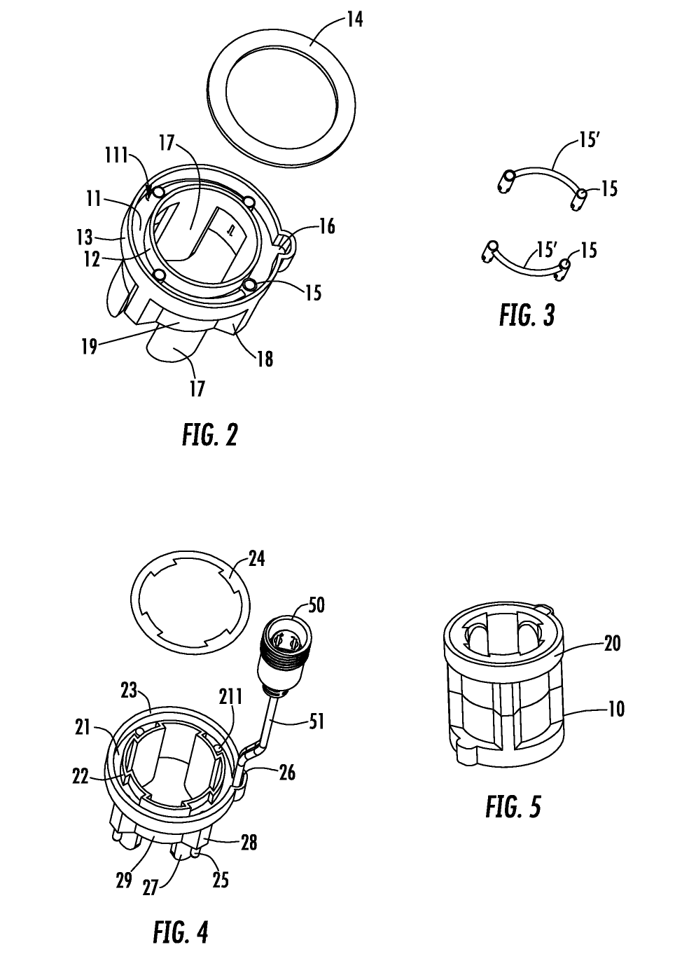

FIG. 1 to FIG. 5, an embodiment of the invention, the combined power socket comprises the first matched socket 10 and socket 20 and socket second, the first 10 and second 20 showed a socket can be sheathed on rod or tube outer surface (such as Christmas tree trunks) ring structure, and when the two ends are respectively sheathed in the first socket 10 and socket 20 or second rod tube are connected with the first, 10 and second sockets socket 20 are connected together.

In this embodiment, the first socket 10 includes an annular ring substrate 11 and substrate from 11 in periphery and periphery perpendicular to the substrate and extends to the first side of the substrate and the inner wall of the outer wall of the 13, 12 and 12 in the inner wall and the outer wall of the annular connecting 13 ends of the cover plate 14. The 12, the inner wall of the inner wall and the outer wall of the base plate 11 are provided with a containing space for containing the conducting wire and the conductive member 13. In addition, the 11 substrate is circular, at the periphery of the outer also extends a convex outer wall, with 13 protruding to the outside and the cover plate 14 is circular, a conductive piece 15 seal the annular space, the outer wall and convex outer lug 13 from a wire outlet hole 16, and exit direction line hole 16 toward the first side of the substrate 11.

The first socket 10 further includes a plurality of insert sheets 17 extending from the inner wall 12 to the substrate side of the substrate and the other side of the back side of the first side, and a plurality of columns extending from the 11 side of the substrate on the second side of the substrate 18. A plurality of through holes of the base plate 11 and the two ends of the column body 18 are formed on the base plate 11 corresponding to the positions of the plurality of column bodies 18. In the embodiment of the invention, the inserting sheet 17 is a piece of 4 pieces, which is uniformly and symmetrically distributed. The jack 11 is also provided with a symmetrical distribution of 4, and each jack is arranged between the adjacent two inserting pieces of the present disclosure, and the two jacks are a group of the same, and the electric connector is electrically connected with the electric conduction part of the jack in the same group of the, which is arranged in the jack of the same group of 15.

In this embodiment, the conductive part 15 is 111, the size of Jack and diameter of metal tube, Jack of the same group in the metal tube toward the end cover plate 14 through a curved guide tube or conductive rod or conductive wire 151 is electrically connected together. In addition, the other end of the conductive member 15 is provided with a plurality of notches, so that the end part is in a claw shape, which is convenient for inserting the corresponding rod pin to realize the electric connection. In this embodiment, the other end of the conductive member 15 does not extend outside the jack 111.

A conductive wire 30 which is connected with one end of the power plug 31 which is suitable for being matched with the external power socket is connected with the conductive part 15 from the outlet hole 16 into the accommodating cavity of the first socket. In addition, one or more wires connected with one end of the power supply connector 40 is also connected with the conductive part 15 from the outlet hole 16 into the accommodating cavity of the first socket 10. The power supply connector 40 is matched with the external electric equipment, such as the electrical connection terminal of the lamp string of the Christmas tree.

In addition, 11 of the substrate second side is formed with a connecting cylinder 18 and the lateral surface of the 17 inserting ring 19, ring 19 and the height of the column 18, but less than 17 insert height, to insert more than 17 ring body 19 to the substrate second side 11 further extension. Ring 19 increases the strength of the insert 17.

FIG. 1 also shows another structure with the first socket 10 basically the same with the first expansion socket 10′, with the only difference between the first conductive line 31 socket 10 is connected to the power plug is not connected to external power supply, but a first conductive joint 30″. In the embodiment, the first conductive joint 30 is a small two pin plug.

Please also refer to FIG. 4 and FIG. 5, second socket 20 includes second substrate 21, a ring from the second substrate 21 inner periphery and the outer periphery perpendicular to the substrate and the second substrate second to the first side extending from the annular inner wall and the second wall second 22 23, 22 and second are connected with the annular inner wall second at the end of second the 23 outer cover 24. The second base plate 21, the inner wall of the inner wall of the 23 and the second outer walls of the 22 and the second are surrounded to foam a containing space for containing the conducting wires. In addition, with the first socket 10 similar to that of the second substrate 21 peripheral circular outer circumference also extends a convex outer wall, second with 23 protruding to the outside and second cover 24 peripheral circular shape inner peripheral shape and second substrate 21 corresponding which can seal the second walls 22, second the guide wire substrate accommodating space, and the outer wall of the convex outer hug 23 forming a guide wire second outlet hole 26, and the outlet hole 26 exit direction toward the second substrate 21 first side.

Second socket also comprises a plurality of second and 20 from second to second inner walls of the 22 substrate 21 contrary to the first side of the second side of the inserting piece 27, and from the second side of the second substrate 21 toward the second substrate extending from a plurality of second cylinder 28. 21 a plurality of through holes on both ends of the second base plate and the two column body are formed on the base plate of the second base plate corresponding to the positions of the plurality of the second column bodies 21, 211. In the embodiment of the invention, the second inserting piece 27 is a piece of 4 pieces, which is uniformly and symmetrically distributed. The second column body 28 (through a hole of second) is also in the form of a symmetrical distribution of the 4 cylinders, and each of the second column bodies is arranged relative to the one of the second inserting plates (211). The size of each of the 28 cylinders. Each through hole 211 is inserted into a conductive pin 25, and two through holes 211 for a group of conductive pins through holes of the same group in 25 is electrically connected as anode or cathode and a second outlet hole from 26 into the second accommodating cavity socket 20 conductor 51 electrical connection. The second conductive wire connector 51 is located in the second external socket 20 is connected with the other end of a first expansion socket 10′30′ first conductive joint adaptation of 50 (this example is a small two hole outlet)

In addition, the second substrate second side 21 is formed with a connecting all second cylinders 28 and second lateral surface of the 27 inserting the second ring body 29, the second and 29 body height second column 28, but less than second piece 27 of the height of second to 27 more than the second ring body is inserted to the 29 the second side of the second substrate 21 further extension. The second ring body 29 increased the strength of the second insert 27. Furthermore, the conductive pin 25 extends outward front the through hole 211 in the second cylinder body, but not more than second of the 27 end of the insert.

When in use, the first second socket 10 and socket 20 spliced together insert 17 and second insert 27 mutually staggered cross simply insert the ring body 19 and the second ring body 29 inner ring body 19 and the second 29 offset, 25 conductive pins inserted into the jack 111 and 15 claw shaped conductive insert end within the Department, to realize electrical connection, the first second socket 10 and socket 20 rely on friction between the insert and the ring body are tightly connected together. At this time, the power input of the combined socket only depends on the power supply connector 40. If the number of the power supply connector 40 is to be extended, the first conductive joint 30 of the first socket 10 is expanded to be connected with the electric connector of the second socket of the first socket 20, which is connected with the second conductive joint.

In other embodiments, a guide wire connected to a power supply connector 40 with one or more ends may also be electrically connected to the conductive pin 25 from the outlet hole of the second socket, which is provided with a power supply connector, at a 16 outlet hole of the second socket. Thus, the first socket 10 and the socket 20 are provided with a power supply connector, which is provided with a power supply connector. The connector is provided with a power supply connector 40. It is understood that two or more power supply connectors may be drawn on the first socket 10 and/or the socket on the basis of the need to be connected with the power supply, as required, by 40, or at least one, and a plurality of power supply connectors, which are provided with a plurality of power supply connectors. The output of the first socket is provided with a plurality of power supply.

It is understood that, in order to prevent short circuits, the first socket 10 and the socket 20 of the second socket shall be provided with an electrical connection polarity wanting mark to prevent short circuit.

In other embodiments, the power supply connector 40 can be extracted from the second socket only 20, and the first socket is provided with a power supply plug 30 or a first conductive joint only.

In other embodiments, according to the size of the combined power socket and the need to adjust the number of inserts, each socket has 2 or 3 or more than 4 sockets. The number of the jacks on the first socket can be only 2, which can be relatively arranged or close to the set, and the corresponding number of the conductive pins cart be only 2. In addition, the number of the jack and the conductive pin can be set to be different, as long as the number of the conductive pins is larger than the number of the jacks. In these embodiments, the polarity of the conductive pins and the conductive elements within the jack can be provided as required.

In other embodiments, the position of the outlet hole can be arranged on the outer wall of the first socket and the second socket, such as the outer wall 13 and the outer wall of the outer wall 23. The outlet hole can also be arranged on the cover plate 14 and the cover plate 24, so that the peripheral shape of the substrate 11 and the second substrate 21 can be a positive circle.

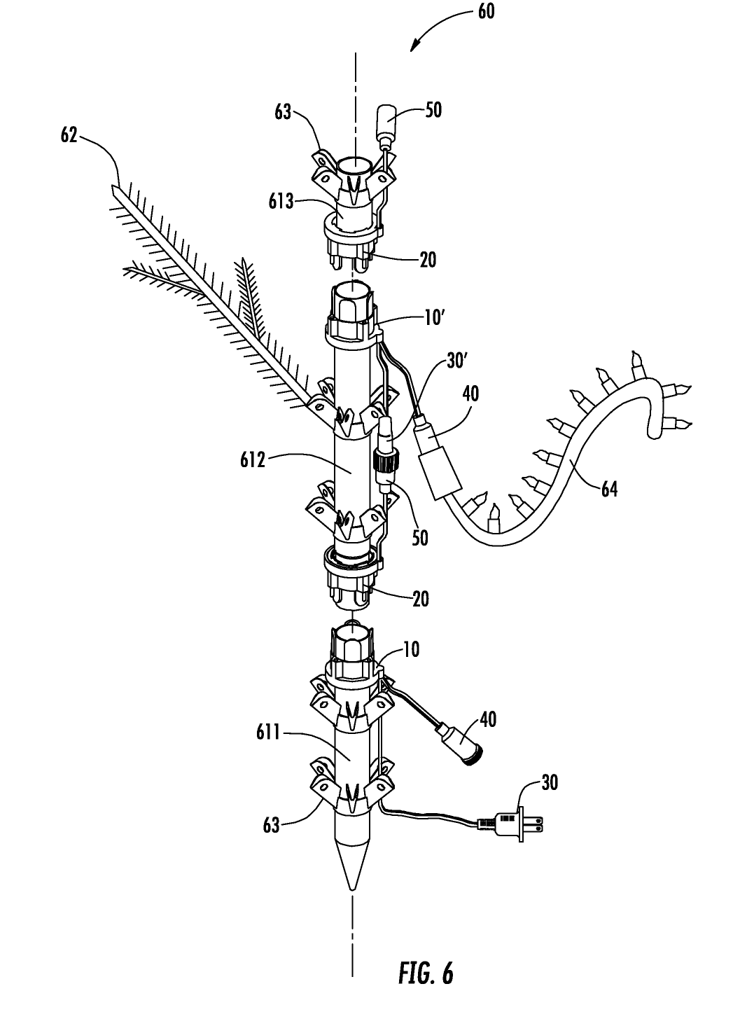

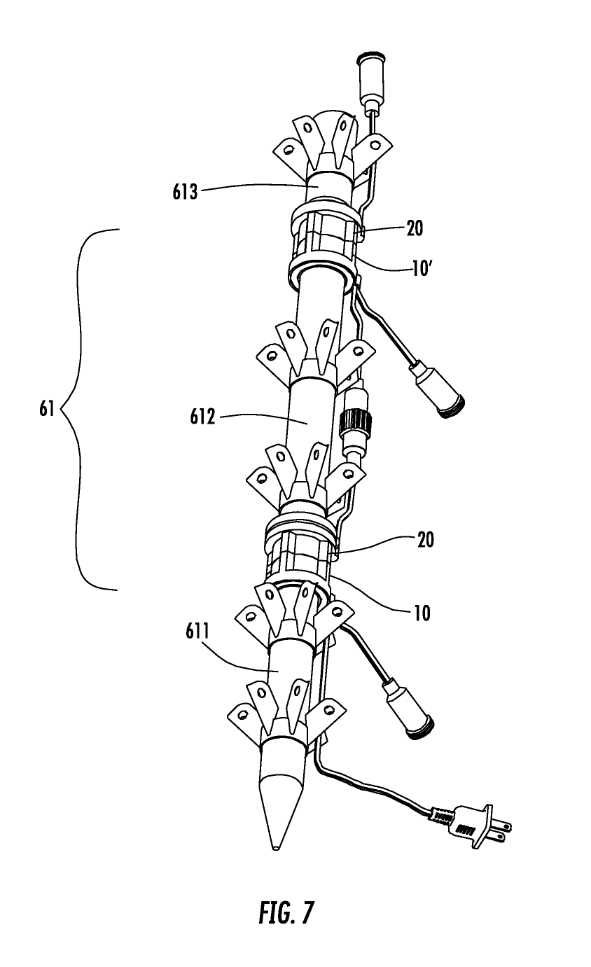

FIG. 6 and FIG. 7 show the structure of the combined power socket when it is used on the Christmas tree. Among them, the Christmas tree 60 includes a section of the trunk tree 61, the tree is connected to the trunk of the tree to connect the branches of the bracket 63, and hanging on the branches of the lights on string of 64, three, 62. The 611 section 61 trunk at the upper end of the peripheral socket (interference connection or fixed by screw connection socket) first 10; middle trunk 612 lower peripheral socket second socket 20, socket upper peripheral expansion socket 10′; the first 613 at the lower end of the upper trunk peripheral sheathed with another second socket 20. When the three section of the trunk are connected with each other, the end of each plug trunk, the first second socket 10 and socket 20 mechanical and electrical connection, extended with the first socket 10′ and another second socket 20 mechanical and electrical connection. When the second conductive joint of the socket 20 of the second socket is connected with the first conductive joint of the first socket, which is extended to be used as a first socket, the current from the power supply plug 30 can be transmitted to the other socket of the other 20 (30), which is connected with the other end of the first socket of the socket, which is 10. The lamp string 64 can be electrically connected to the power supply connector 40. Since all the conductive wires are inserted from the outside of the trunk line, the connection is convenient and quick. Because the flexible wire is used to draw out the power supply connector 40, the connection of the lamp string is more convenient and quick, and the manufacturing process of the first socket and the second socket is greatly simplified.

Although the present disclosure is the description of the concrete embodiment of the combination of the above, however, familiar with the personnel in the technical field according to the contents of many alternatives, modify and change, is obviously. Therefore, all such alternatives, improvements and changes are included in the scope of the spirit and requirements of the rights in the attached.

What is claimed is:

1. A combined power socket for artificial Christmas trees, including supporting each other first and second socket, which is characterized in that the first socket and second socket were can be sleeved on the ring structure of rod or tube outer surface; the first socket and socket second in one form first at the end of a jack, Jack as arranged in the conducting part, another form first end is provided with a plurality of conductive pins and a plurality of the plurality of jacks corresponding to the lateral wall and both on or near the lateral wall is formed with the socket outlet hole communicated with the inner hole of the outlet; the first and second socket one inside by a wire leads the first conductive connector is also one of the outlet hole through the guide wire leads to a second conductive contact with the first conductive connector of the adapter or a and At least one of the first socket and the second socket is provided with at least one power supply connector through a conducting wire.

2. Combined power supply socket 2 according to claim 1 wherein, characterized in that the first socket and second socket have extended to form at least one out, and can be inserted into another ring to make two separable connecting the inserting piece together.

3. According to the requirements of the rights of the combination of 2 power outlet, is characterized in that the first socket includes:
Annular substrate;
An annular inner wall and an outer wall extending from the inner periphery of the substrate and the outer periphery perpendicular to the substrate and extending from the first side of the substrate;
Annular cover plate connected to the inner wall and the outer wall end to seal the space between the substrate, the inner wall and the outer wall;
A plurality of inserting sheets extending from the inner wall to the second side of the substrate; and
A plurality of columns extending from the second side of the substrate toward the substrate are formed, and a plurality of through holes which are penetrated through the base plate and the two ends of the column are formed on the substrate;
The conductive member is inserted into the plurality of jacks from the first side of the substrate, and the conductive member is electrically connected to the conductive wire introduced through the outlet hole.

4. According to claim 4 of the 3 combined power supply socket, which is characterized in that the insert into 4 pieces, symmetrical distribution; the jack is 4, a symmetrical distribution, and each jack is arranged between two adjacent inserts, and two jacks for a group, with Jack a group within the conductive member electrically connected.

5. According to claim 5 of the 4 combined power supply socket, which is characterized in that the conductive piece size and the diameter of the metal tube, Jack, Jack of the same group in the metal tube toward the end cover through an arc-shaped conductive tube or conductive rod or conductive metal wires are electrically connected together.

6. According to claim 6 of the 3 combined power supply socket, which is characterized in that the second side of the substrate is formed with a ring body connecting the column body and insert the outer surface of the column height and the ring body of the same, but less than the height of insert, which inserts over the ring body the extension to the second side beyond the base plate.

7. according to the claim 6, the combined power socket is characterized in that the second socket comprises a socket:
Annular second substrate;
The annular second inner wall and the outer wall extending from the inner periphery of the second substrate and the outer periphery perpendicular to the substrate and extending from the first side of the second substrate;
An annular second cover plate which is connected to the inner wall of the inner wall and the outer wall of the outer wall of the second base plate, the inner wall of the second base plate, the inner wall of the second outer wall and the second outer wall;
A plurality of second inserts extending from the inner wall of the second to the second side of the second substrate; and
From the second substrate to the second side of the second substrate and extending out of more than second columns, the second substrate corresponding to the second column position is formed with a plurality of second through the second substrate and the two column ends of the through hole;
The plurality of conductive pins are inserted into the second through hole and extend from the end of the second column, and the conductive pins are electrically connected with the conductive wires which are introduced through the corresponding outlet holes.

8. Combined power supply socket 8 according to claim 7 wherein, characterized in that the second inserted into 4 pieces, symmetrical distribution; the second column is 4, a symmetrical distribution, and each of the second columns and second insert relative set.

9. Combined power supply socket 9 according to claim 8 wherein, characterized in that the second side of the second substrate is formed with a second body connecting the second cylinders and second insert on the outer surface, height and the second column the second ring of the same, but less than second insert height thus, second more than the second insert body extends farther to the second side of the second substrate.

10. According to claim 10 combined power socket 1 to 9 in any one of the, which is characterized in that the first inserted in a tree of the lower seat section second socket is sheathed on the upper section of the tree, the upper section of the lower section and connected together, and the first socket second electrical connection.
